(19) United States
(12) Patent Application Publication
(10) Pub. No.: US 2020/0245380 A1
(43) Pub. Date: Jul. 30, 2020

(54) SYSTEMS AND METHODS FOR CONTROLLING MEDIA CONTENT IN A MULTI-USER AND MULIT-DEVICE ENVIRONMENT USING A WIRELESS COMMUNICATION DEVICE

(71) Applicant: VTV Technologies, Inc., Burr Ridge, IL (US)

(72) Inventors: Bret Hruby, Burr Ridge, IL (US); Michael Zhao, Burr Ridge, IL (US)

(73) Assignee: VTV Technologies, Inc., Burr Ridge, IL (US)

(21) Appl. No.: 16/849,928

(22) Filed: Apr. 15, 2020

Related U.S. Application Data
(63) Continuation-in-part of application No. 16/798,058, filed on Feb. 21, 2020.
Application No. 16/798,058 is a continuation of application No. 15/371,160, filed on Dec. 6, 2016, now Pat. No. 10,575,342.

(51) Int. Cl. H04W 76/10; H04N 21/4367; H04N 21/6377; H04L 29/06; H04W 12/06

(52) U.S. Cl. CPC H04W 76/10; H04N 21/4367; H04N 21/63775; H04W 48/20; H04L 65/4084; H04L 65/4069; H04W 12/06; H04L 65/4092

(57) ABSTRACT

This disclosure relates to systems and methods for controlling media content transmitted from a wireless device in a wireless communication network to a media content streaming gateway, which may be communicatively coupled to a media content streaming device in a multi-user multi-device environment. Users associated with client computing platforms may obtain authentication to the wireless communication network assignment to a particular gateway device. Users may be able to effectuate a wireless data communication session between their client computing platform and media content streaming gateway.

### RELATED APPLICATIONS

This application is a continuation-in-part of U.S. patent application Ser. No. 16/798,058, filed on Feb. 21, 2020, which is a continuation of Ser. No. 15/371,160, filed on Dec. 6, 2016, which is now U.S. Pat. No. 10,575,342, the contents of which are incorporated herein by reference in its entirety.

### TECHNICAL FIELD

The present disclosure relates to systems and methods for controlling media content with a wireless device in a wireless and/or wired communication network via a media content streaming device communicatively coupled to a media content streaming gateway.

### BACKGROUND

It is been known that users are increasingly using wireless mobile devices such as smart phones, tablets, and the like that provide Internet connectivity. In using these devices, users are consuming media from various sources on the Internet and on their wireless mobile devices. With the growth of media streaming cast devices like Chromecast™ and Apple TV™, users can stream data from their wireless mobile devices or the Internet.

### SUMMARY

In accordance with one or more embodiments, various features and functionality can be provided to enable or otherwise facilitate media content transmission in a multi-device and multi-user environment.

In some embodiments, a method for transmitting media content in a multi-user environment may include establishing a wireless communication session between an individual mobile device and a gateway device by authenticating the individual mobile device during an authentication process. The mobile device operated by a user may include an individual device of a plurality of mobile devices operated by a plurality of users.

In some embodiments, the media content may be received by the gateway device from the authenticated mobile device during the wireless data communication session and transmitted to a display device via a streaming device. In some embodiments, the gateway device is configured to communicatively couple the streaming device and the streaming device may be configured to communicatively couple a display device.

In some embodiments, the gateway device may include a WiFi module, a first interface configured to communicatively couple the streaming device, a second interface configured to communicatively couple a power source, and a third interface configured to communicatively couple the display device. In some embodiments, the streaming device may be configured to be communicatively coupled to the display device via a high definition multimedia interface (HDMI).

In some embodiments, the wireless communication session between the individual mobile device and the WiFi module of the gateway device may be established by authenticating the user associated with the individual mobile device by assigning the individual mobile device to the WiFi module. The assigned individual mobile device may transmit media content onto the display device via the streaming device communicatively coupled to the gateway device. In some embodiments, the assigned WiFi module of the gateway device may be communicatively coupled to a network. In some embodiments, the individual mobile device may be configured to access a global internet using the assigned WiFi module of the gateway device. In some embodiments, the individual mobile device may be configured to transmit media content to the gateway device over one or more communication protocols comprising at least one of Bluetooth, Wi-Fi, near field communication, and RFID communication protocols; wherein the media content is received from the global internet.

In some embodiments, the media content transmitted by the individual mobile device may be received by the gateway device and transmitted to the streaming device via the first interface for display onto the display device.

In some embodiments, the first interface of the gateway device may include a micro-USB port configured to interface with a micro-USB receptacle onboard the streaming device.

In some embodiments, the first interface may be configured to deliver an electrical power flow for powering the streaming device; and wherein the electrical power flow is directed from the power source communicatively coupled to the second interface.

In some embodiments, wherein the gateway device further comprises a power regulator configured to regulate the electrical power flow to the streaming device.

In some embodiments, the gateway device may include a user interface configured to receive input for specifying a mode of operation of the streaming device, e.g., a first mode and a second mode. The first mode of operation may allow the streaming device to be powered continuously, while the second mode of operation may allow the streaming device to be powered non-continuously.

In some embodiments, the gateway device may include a power MOSFET configured to transmit a signal to power on the streaming device upon receiving a first input from the display device and to transmit a signal to power off the streaming device upon receiving a second input from the display device. The first input from the media display device may indicate that the display device is powered on, and the second input from the media display device may indicate that the display device is powered off. In some embodiments, the first input and the second input from the display device may be delivered to MOSFET via the third interface of the gateway device. In some embodiments, the third interface may include mini-USB receptacle configured to interface with a min-USB port onboard the display device.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

FIG. 1 illustrates example systems and a network environment, according to an implementation of the disclosure.

FIG. 2 illustrates a schematic of a media content streaming gateway of FIG. 1, according to an implementation of the disclosure.

FIG. 3 illustrates a WiFi module of media content streaming gateway of FIG. 2, according to an implementation of the disclosure.

FIG. 4 illustrates a system for controlling media content with a client computing device, according to an implementation of the disclosure.

FIG. 5 illustrates a method for controlling media content with a client computing platform, according to an implementation of the disclosure.

FIG. 6 illustrates an example computing system that may be used in implementing various features of embodiments of the disclosed technology.

### DETAILED DESCRIPTION

Described herein are systems and methods for controlling media content with a client computing device in a multi-user and multi-device environment.

The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

As alluded to above, most owners of wireless mobile devices use them to consume media from various sources on the Internet. Smartphones remain the most popular devices for consumer media, while tablet use continues to lose ground. Accordingly, streaming video content (e.g., TV shows and movies) has become a primary way to entertain and engage with customers, especially with companies like media content providers Netflix, Amazon, and Apple investing heavily in adding shows and films to their streaming platforms. Using media streaming adapters, such as Amazon Fire TV Stick, Chromecast, and the like, enables users to initiate and control playback of Internet-streamed content from their mobile devices on a high-definition-television connected to such an adapter.

While users have been enjoying the perks of controlling media content with the help of media streaming adapters at home, use of a Chromecast-type device when traveling is not ideal. For example, users attempting to use their own devices in a hotel have to set it up with every new WiFi network, often running into connectivity issues which are difficult to overcome, not to mention are time-consuming and tedious. Additionally, many users have accounts with various providers of media streaming, including media streaming adapters (e.g., Amazon Fire TV Stick and Chromecast) or digital media player platforms (e.g., Apple Amazon Fire TV, Roku, Apple TV, and the like). Because of the increased popularity and demand, multi-room establishments, such as hotels, are interested in providing their guest with a way to enjoy their content in a secure and efficient way.

In accordance with various embodiments, user may initiate and control the display of content from their mobile devices on a display device in a multi-user and multi-device environment by using a media content streaming gateway. The media content streaming gateway may be a single-unit device configured to house a media streaming adapter, a WiFi module, and a connecting device configured to communicatively couple the adapter and the WiFi module, and a power regulator. The circuitry and additional components may support dual band WiFi (e.g., 2.4G and 5G), provide power supply, and allow control of the WiFi adapter and the power regulator. By using the media content streaming gateway that includes the media streaming adapter rather than the media streaming adapter alone, allows user to remotely control the adapter, resulting in a more user-friendly maintenance, which is especially important in a multi-device setting. Additionally, the housing of the media content streaming gateway may be made from a number of suitable materials. For example, a particular aluminum alloy, configured to provide temperature control features.

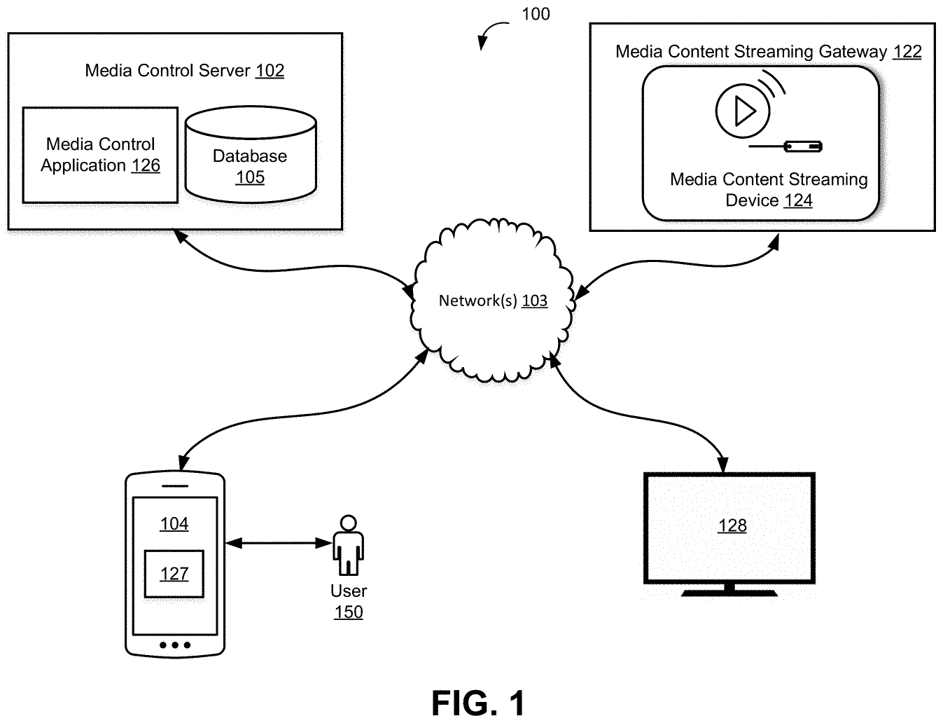

Before describing the technology in detail, it is useful to describe an example environment in which the presently disclosed technology can be implemented. FIG. 1 illustrates one such example environment 100.

FIG. 1 illustrates an example environment 100 which permits individual users to initiate and control content from their mobile device on a display device communicatively coupled to a media content streaming device in a multi-device environment. In some embodiments, environment 100 may include a one or more media control servers 102, a one or more client computing devices 104, a one or more media content streaming gateways 122 which may include a media content streaming adapter or digital media player device 124, a one or more media content display devices 128, a network 103, and/or other components. A user 150 may be associated with client computing device 104 as described in detail below.

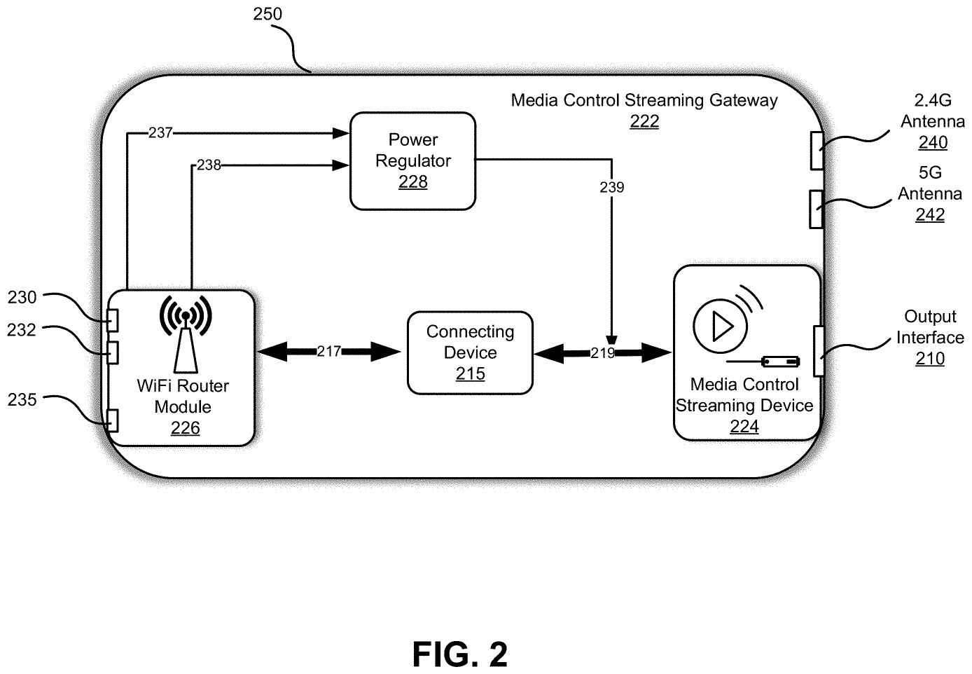

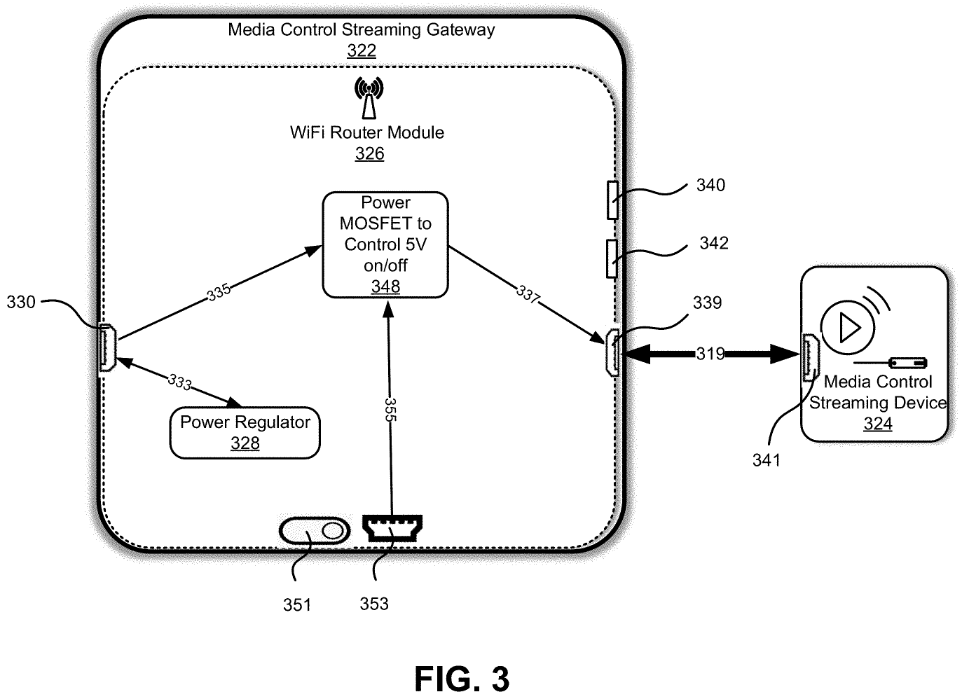

As alluded to above, gateway 122 may be a single-unit device configured to permit users the streaming of media content from their mobile devices on a high-definition television in a multi-user, multi-device environment. In particular, media content streaming gateway 122 is configured to provide this functionality by housing media content streaming device (or digital media player) 124, a WiFi router module, a connecting device (or dongle) configured to communicatively couple streaming device 124 to the WiFi router module, a power regulator, and other components, as further described in FIGS. 2-3.

In some embodiments, media content streaming gateway 122 may include internal components configured to facilitate the connectivity and control of streaming device 124 by external users (e.g., hotel network administrators). The components may include a processor, a printed circuit board, a non-transitory memory configured to store instructions, a wireless transceiver, an antenna, a power source, and/or other components. Additionally, gateway 122 may include a local area network radio interface, a display interface, a user interface (e.g., a power switch), and other components.

In some embodiments, media content streaming device 124 included in gateway 122 may be a hardware device (e.g., an adapter or a digital media player) which allows individual users to display media content (e.g., streamed audio, video or image content) from their respective client computing devices (e.g., client computing device 104) onto display device 128. For example, media content streaming device 124 may include streaming device 124, such as, for example, Chromecast, Amazon, or Fire TV Stick that communicatively couples display device 128. In some embodiments, media content streaming device 124 may receive media content, or an address (e.g., link) to retrieve the media content, from client computing device 104 so that media content streaming device 124 may stream the media content to display device 128. The media content may include, for example, television (TV) shows, movies, music and/or other video, audio or image media content. In some embodiments, media content streaming device 124 may include wired or wireless communication interfaces for communicating with display device 128, client computing device 104, and/or wireless network 103.

In some embodiments, client computing device 104 may include a variety of electronic computing devices, such as, for example, a smartphone, tablet, laptop, computer, wearable device, virtual reality device, augmented reality device, connected home device, Internet of Things (IOT) device, an enhanced general packet radio service (EGPRS) mobile phone, a media player, a navigation device, a game console, a remote control, or a combination of any two or more of these data processing devices, and/or other devices. In some embodiments, client computing device 104 may present content to a user and receive user input. In some embodiments, client computing device 104 may parse, classify, and otherwise process user input.

In some embodiments, client computing device 104 may include one or more components coupled together by a bus or other communication link, although other numbers and/or types of network devices could be used. For example, client computing device 104 may include a processor, a memory, a display, an input device (e.g., a voice/gesture activated control input device), an output device (e.g., a speaker), an image capture device configured to capture still images and videos, and a communication interface.

In some embodiments, media content display device 128 may include a device with audio, video, and image displaying capabilities. For example, media content display device 128 may include a high-definition television or an LED monitor. Media content display device 128 may include a communication interface for connecting to streaming device 124.

In some embodiments, network 103 may be a wireless communication network configured using wireless technologies (e.g., cellular network). For example, network 103 may be a wireless wide-area network (WWAN). Alternatively, network 103 may be a wireless local area network (WLAN) and may use one or more LAN protocols (e.g., IEEE 802.11). For example, network 103 may be configured using communication protocols RF, IrDA (infrared), short-range wireless network (e.g., Bluetooth), ZigBee (and other variants of the IEEE 802.15 protocol), any variation of IEEE 802, such as IEEE 802.16 (WiMAX or any other variation) and IEEE 802.20, GSM, CDMA, TDMA, GPRS, EDGE, LTE, UMTS, and/or other communication protocols. In other embodiments, network 103 may be configured using wired technologies, such as Ethernet.

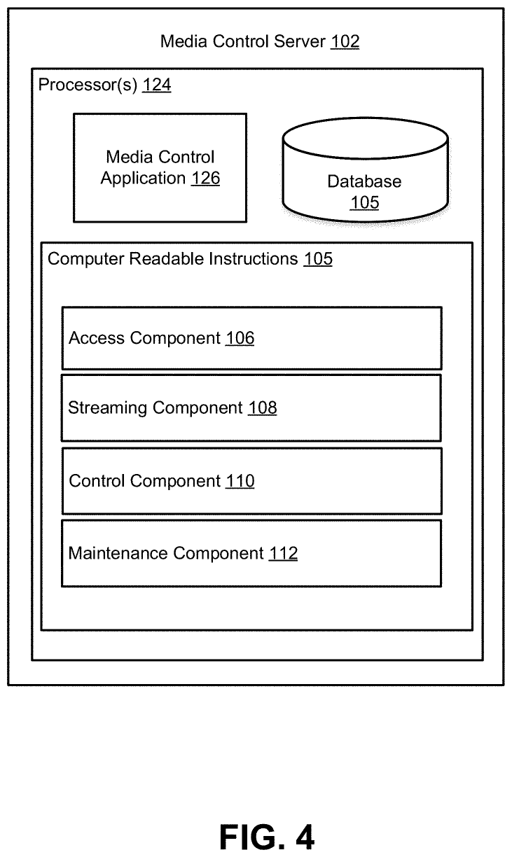

In some embodiments and as will be described in detail in FIG. 4, media control server 102 may be configured to store and manage information associated with media content streaming. Media control server 102 may include processor(s), a memory, and a communication interface, which are coupled together by a bus or other communication link, although other numbers and/or types of network devices could be used. In some embodiments, media control server 102 may also include a database 105. In some implementations, media control server 102 may be provided in a virtualized environment, e.g., media control server 102 may be a virtual machine that is executed on a hardware server that may include one or more other virtual machines. Additionally, in one or more embodiments of this technology, virtual machine(s) running on media control server 102 may be managed or supervised by a hypervisor. Media control server 102 may be communicatively coupled to network 103.

In some embodiments, the memory of media control server 102 can store application(s) that can include executable instructions that, when executed by media control server 102, cause media control server 102 to perform actions or other operations as described and illustrated below with reference to FIG. 4. For example, media control server 102 may include media control application 126. In some embodiments, media control application 126 may be a distributed application implemented on one or more client computing devices 104 as media control application 126. In some embodiments, distributed information intake application 126 may be implemented using a combination of hardware and software. In some embodiments, media control application 126 may be a server application, a server module of a client-server application, or a distributed application (e.g., with a corresponding media control client 127) running on one or more client computing devices 104).

The application(s) can be implemented as modules, engines, or components of other application(s). Further, the application(s) can be implemented as operating system extensions, module, plugins, or the like.

Even further, the application(s) may be operative in a cloud-based computing environment. The application(s) can be executed within or as virtual machine(s) or virtual server(s) that may be managed in a cloud-based computing environment. Also, the application(s), and even the repair management computing device itself, may be located in virtual server(s) running in a cloud-based computing environment rather than being tied to one or more specific physical network computing devices. Also, the application(s) may be running in one or more virtual machines (VMs) executing on the repair management computing device.

In some embodiments, media control server 102 can be a standalone device or integrated with one or more other devices or apparatuses, such as one or more of the storage devices, for example. For example, media control server 102 may include or be hosted by one of the storage devices, and other arrangements are also possible.

In some embodiments, media control server 102 may transmit and receive information to and from one or more of client computing devices 104, one or more media content gateways 122, one or more media content display devices 128, and/or other components via network 103. For example, a communication interface of media control server 102 may be configured to operatively couple and communicate between client computing devices 104, media content gateways 122, and media content display devices 128, which may all be coupled together by the communication network 103.

In some embodiments, media control server 102, client computing device(s) 104, media content streaming gateway(s) 122 (including media content streaming device(s) 124), and media content display device(s) 128 may be operatively linked via one or more electronic communication links. For example, such electronic communication links may be established, at least in part, via network 103. In some implementations, server(s) 102, client computing device(s) 104, gateway 122, media content display device(s) 128, and/or components may be operatively linked via some other communication methods.

In some embodiments, media control server 102 may be configured to communicate with one or more client computing device(s) 104, media content streaming gateway(s) 122 (including media content streaming device(s) 124), and media content display device(s) 128 according to a client/server architecture. Individual users, e.g., user 150, may access environment 100 via client computing devices(s) 104 associated with individual users. In some embodiments, media control server 102 may include one or more distributed applications (e.g., media control application 126) implemented on client computing device 104 as client applications (e.g., media control client 127).

As alluded to above, gateway 122 may be configured to permit users to stream media content from their mobile devices on a high-definition-television in a multi-user, multi-device environment. For example, as illustrated in FIG. 2, media content streaming gateway 222 may be a single-unit device configured to house a streaming device 224, a WiFi router module 226, a power regulator 228, a connecting device 215, and/or other such components in a housing 250.

In some embodiments, WiFi router module 226 of media content streaming gateway 222 may be configured to permit wireless, wired, and/or other type of connection between media content streaming gateway 222 (i.e., the components of gateway 222 such as streaming device 224) and network 103, client computing devices 104, and/or other components of environment 100 illustrated in FIG. 1 (e.g., media content display device 128). For example, WiFi router module 226 may be configured as an access point for providing wireless and/or wired access to network 103. Authentication processes may be implemented to ensure secure and credentialed access onto network 103.

In some embodiments, WiFi router module 226 may include one or more LED indicators. For example, a wide area network (WAN) indicator 230, and a local area network (LAN) indicator 232. In some embodiments, upon establishing a connection between WiFi router module 226 and WAN, WAN indicator 230 may be configured to provide visual indication of the WAN connection. Similarly, establishing a connection between WiFi router module 226 and LAN, LAN indicator 232 may be configured to provide visual indication of the WAN connection.

In some embodiments, WiFi router module 226 may be configured to support an infrastructure data system. For example, an infrastructure data system may be a honeycomb management system, developed by Etonnet for Internet of Things (IoT) and media streaming modalities. In some embodiments, infrastructure data system may host one or more media streaming configurations.

In some embodiments, the infrastructure data system may be configured to allow remote monitoring and management of the media content streaming gateway 222. For example, an administrator of the infrastructure data system may provide remote management services to the content streaming gateway 222. This may be done via a remote monitoring application associated with the infrastructure data system.

In some embodiments, WiFi router module 226 may transmit and receive data from an infrastructure data system. For example, WiFi router module 226 may use a web service and remote call API protocol for transmitting data to the infrastructure data system (e.g., Honeycomb management system). In some embodiments, the data transmitted by WiFi router module 226 may include service data of content streaming gateway 222, e.g., connectivity data, power consumption data, and so on.

In some embodiments, streaming device 224 may be configured to communicatively couple WiFi router module 226 using wireless, wired, and/or other type of connection to effectuate data communication of media content streaming gateway 222.

In some embodiments, streaming device 224 included in media content streaming gateway 222 may be a streaming device (e.g., Chromecast, Amazon, Fire TV Stick, or such similar adapter or a digital media player.) which allows individual users to display media content from their respective client computing devices (e.g., client computing device 104 illustrated in FIG. 1) onto a display device (e.g., display device 128 illustrated in FIG. 1). In some embodiments, streaming device 224 may be configured to communicatively couple a media content display via an output interface 210. For example, output interface 210 may be an HDMI connector and/or other such connector.

In some embodiments, connecting device 215 of media content streaming gateway 222 may be configured to integrate streaming device 224 with WiFi router module 226. For example, connecting device 215 may be an AX8877x device. In some embodiments, connecting device 215 may include an interface 219 for coupling streaming device 224 and an interface for coupling WiFi router module 226. For example, interface 219 may be micro-USB interface and interface 217 may be an Ethernet interface. In some embodiments, interface 219 may include a AX8877x USB chipset to 10/100 Fast Ethernet/HomePNA/HomePlug controller and/or other interface. In some embodiments, interface 219 of connecting device 215 and include embedded 28 KB SRAM for packet buffering, a USB interface to communicate with a USB host controller, compliant with USB specification V1.0, V1.1 and V2.0. In some embodiments, connecting device 215 may implements 10/100 Mbps Ethernet LAN function based on IEEE802.3, IEEE 802.3u, HomePNA standard, and/or other standards. In some embodiments, connecting device 215 may integrate an on-chip 10/100 Mbps Ethernet PHY. In some embodiments, connecting device 215 may be configured to directly receive Ethernet data via Ethernet controller 217 from wireless and/or wired communication network 103 (e.g., as illustrated in FIG. 1) via WiFi router module 226.

In some embodiments, some components of media content streaming gateway 222 may provide paths by which electrical power may flow to streaming device 224, connecting device 215 and/or other components of media content streaming gateway 222. By including components configured to power to streaming device 224, connecting device 215 and/or other components of media content streaming gateway 222, eliminates the need for streaming device 224 to have its on-board power source.

In some embodiments, WiFi router module 226 may be configured to power streaming device 224 and/or connecting device 215. For example, WiFi router module 226 may supply electrical power flow to power regulator 228, which is configured to regulate the electrical output used to power streaming device 224 and connecting device 215. In some embodiments, an indicator, e.g., power indicator 235 may be configured to provide visual indication of the power flow.

As alluded to above, power regulator 228 may be configured to modulate the electrical input 237 received from WiFi router module 226. For example, power regulator may receive a 12V DC input 237 and output 5V DC output for powering streaming device 224 and connecting device 215.

In some embodiments, WiFi router module 226 may be configured to control the powering-on and powering-off of streaming device 224 via input to power regulator 228. For example, WiFi router module 226 may control the powering-on and powering-off of streaming device 224 via input 238 to power regulator 228.

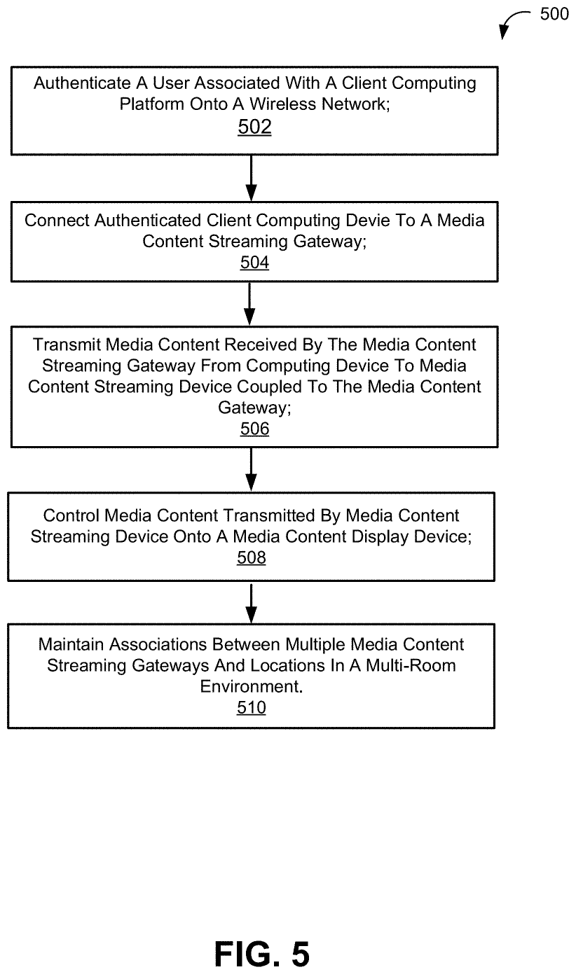

By virtue of controlling the power supply to the components of media content streaming gateway 222 via WiFi router module 226, the user is able to monitor and control the power consumption of streaming device 224 remotely. For example, via a user interface as described in FIG. 5.

In some embodiments, other sources of power may be used to power the components of media content streaming gateway 222. For example, media content streaming gateway 222 may be configured to receive electrical input from an external source, such as an external power supply. The electrical input supplied by the external source may be used to power streaming device 224 and/or other components.

In some embodiments, a user interface of media content streaming gateway 222 may include a power-on capability. This capability may be a switch, button, or other method of powering on and off media content streaming gateway 222. In some embodiments, this capability may be configured to be accessed via network 103 for remote control of power-on capabilities.

In some embodiments, media content streaming gateway 222 may be configured to operate over one or more WiFi channels accessed using IEEE 802.11 protocols. For example, media content streaming gateway 222 may operate over 2.4 GHz and 5 GHz channels. In some embodiments, media content streaming gateway 222 may include circuitry such as a wireless transceiver coupled to one or more antennae and/or other components configured to operate within specific frequency bands. For example, antenna 240 and may be configured to operate in 2.4 GHz frequency band and antenna 242 and may be configured to operate in 5 GHz frequency band. In some embodiments, media content streaming gateway 222 may include a dual-band frequency antenna configured to operate in 2.4 GHz and 5 GHz frequency bands.

In some embodiments, media content streaming gateway 222 may be configured to include a printed circuit board (PCB) configured to support a WiFi router module, as illustrated in FIG. 3. For example, gateway 322 may be configured to house a PCB WiFi router module 326 (similar to WiFi router module 226 illustrated in FIG. 2). By virtue of integrating WiFi router module 326 into the PCB results in a smaller formfactor of media content gateway 322 as compared to a formfactor of gateway 322.

In some embodiments, PCB WiFi router module 326 of gateway 322 may include a plurality of electrical and electronic components configured to support one or more connectors for powering and controlling streaming device 324. For example, PCB WiFi router module 326 may support a micro-USB receptacle (female) 330 for interfacing with an external power supply, a power regulator 328, a metal-oxide-semiconductor field-effect transistor (MOSFET) 348, a micro-USB plug (male) 339 for interfacing with streaming device 324, and a mini-USB receptacle (female) 353 for interfacing with a media content display device, a slide switch 351, and transmission antennae 340, 342, as will be described in detail further below.

As alluded to above, an external power source may supply power to gateway 322 by interfacing via micro-USB receptacle (female) 330. In some embodiments, a power adapter associated with streaming device 324 (e.g., Chromecast) may be used to connect into an external power source and micro-USB receptacle 330.

In some embodiments, the electrical power flow 333 received from an external power source may be directed from micro-USB receptacle 330 to power regulator 328. In some embodiments, power regulator 328 may be configured to regulate and/or modulate electrical input 333 used to power streaming device 324. For example, power regulator 328 may modulate input 333 from 1.8 V/3.3 V DC to 5V DC. In some embodiments, the modulated input 335 may be directed to power MOSFET 348. The output 337 from power MOSFET 348 may be configured to power micro-USB plug 339, which in turn may be configured to communicatively couple streaming device 324. By using an integrated power MOSFET 348, gateway 322 may reduce power consumption required for powering streaming device 324. Additionally, power MOSFET 348 may be configured to control the powering-on and powering-off of streaming device 324, as will be described in detail below.

In some embodiments, PCB WiFi router module 326 may be configured to control the powering-on and powering-off of gateway 322 and/or streaming device 324 upon detecting that the media display device (e.g., device 128 illustrated in FIG. 1) is powered on or powered off, respectively. In some embodiments, PCB WiFi router module 326 may be configured to receive input 355 from media display device coupled to PCB WiFi router module 326 via mini-USB interface (female) 353. That is, input from media display device via mini-USB interface 353 may be used to detect whether media content display device is on or off. In some embodiments, MOSFET 348 may receive input 355 from media display device and upon detecting a particular state of the media content display device (e.g., on or off) may turn on or off streaming device 324 via input 337.

In some embodiments, gateway 322 may be configured to support one or more operational modes. For example, a first mode may include a scenario in which gateway 322 (and its PCB WiFi router module 326) is always on (continuous mode). Conversely, a second operational mode may include scenario in which gateway 322 is only on when a media display device (e.g., a TV) is also on (non-continuous mode). The operational modes may be controlled via a user interface. For example, a slide switch 351 may allow the user to switch between the two operational modes, as described above. In some embodiments, the operational modes may be supported by using the input from mini-USB interface 353 which detects the state of the media content display device, as alluded to above.

As alluded to above, streaming device 324 may be powered by an external power source (connected to micro-USB receptacle 335 onboard PCB WiFi router module 326) by virtue of being communicatively coupled to PCB WiFi router module 326 of gateway 322. In some embodiments, streaming device 324 may be communicatively coupled to PCB WiFi router module 326 via connection 319. This connection is formed between micro USB (male) port 339 supported by PCB WiFi router module 326 and a corresponding micro-USB (female) receptacle 341. In some embodiments, streaming device 324 may not have a corresponding micro-USB (female) receptacle. In that case, an adapter configured to communicate between the receptacle on board streaming device 324 and micro USB (male) port 339 may be used.

In some embodiments, in addition to supplying power to streaming device 324, as explained above, PCB WiFi router module 326 may also be configured to transfer data between PCB WiFi router module 326 and streaming device 324. For example, upon connecting micro USB (male) port 339 onboard gateway 322 into micro-USB (female) receptacle 341 onboard streaming device 324, PCB WiFi router module 326 may be configured to receive and transmit network data between gateway 322 and media content streaming device 326.

In some embodiments, the data transmission may be accomplished by configuring the micro-USB port 339 to operate in OTG (On-the-Go) mode. The micro-USB port 339 operating in OTG mode can both power streaming device 324 and transmit stably transmit network data over to content streaming device 324. Thus, by using micro-USB port 339 in OTG mode, allows the gateway 322 to provide both power and data transmission functionality using a single interface (i.e., micro-USB port 339). Accordingly, by virtue of using OTG mode of the micro-USB port 339 results in a smaller formfactor of media streaming gateway 322, which in turn provides a more consumer-friendly design, also results in lower manufacturing costs (e.g., lower BOM cost).

Alternatively, in some embodiments, micro-USB port 339 may not be configured to transfer data between streaming device 324 and PCB WiFi router module 326. In that case, the data between streaming device 324 and PCB WiFi router module 326 may be transferred via a network connection (e.g., a WiFi connection) rather than a physical connection.

In some embodiments, gateway 322 may control the data transmission from client computing device (e.g., client computing device 104 illustrated in FIG. 1) to the streaming device 324 by directly connecting to a media content server from which client computing device is streaming the media. For example, upon receiving the initial media stream from client computing device via a network connection (e.g., WiFi), media streaming gateway 322 may use application program interface (API) connection to directly communicate with the media server. By having a direct communication between media streaming gateway 322 and the media application server, allows the user to stream the media content without using their client computing device.

In some embodiments, gateway 322 may be configured to operate over one or more WiFi channels accessed using IEEE 802.11 protocols. For example, gateway 322 may operate over 2.4 GHz and 5 GHz channels. In some embodiments, gateway 322 may include circuitry such as a wireless transceiver coupled to one or more antennae and/or other components configured to operate within specific frequency bands. For example, antenna 340 may be configured to operate in 2.4 GHz frequency band and antenna 342 and may be configured to operate in 5 GHz frequency band. In some embodiments, gateway 322 may include a dual-band frequency antenna configured to operate in 2.4 GHz and 5 GHz frequency bands.

Referring back to FIG. 1, as alluded to earlier, multiple media content streaming gateways and/or media content streaming devices may be configured within a multi-room environment. A multi-room environment may be a hotel, a hospital, a cruise ship, an educational institution, a business, and/or other environments. Multiple media content streaming devices may be configured within multiple locations within a multi-room environment. Individual locations or rooms within a multi-room environment may include hotel rooms in a hotel, cruise ship cabins on a cruise ship, classrooms in an educational institution, offices within a business establishment, and/or other locations.

In some embodiments, gateway 122 may be configured to act as an access point and provide access to network 103 to client computing devices 104.

In some embodiments, individual media content streaming gateways 122 may be configured to provide services to more than one room or location within a multi-room environment. Alternatively, multiple media content streaming gateways may be servicing a single location. In some embodiments, individual media content streaming gateways 122 may have multiple radios, each available to serve a different guest or communication need.

As alluded to above, streaming device 124 may be configured to effectuate the streamed media content onto media content display device 128. One or more streaming device 124 may be configured to communicatively couple media content display device 128. For example, streaming device 124 may be directly connected to media content display device 128 via an HDMI, a Universal Serial Bus (USB), and/or other connections. In some embodiments, media content streaming devices 124 may be connected to media content display device 128 via a cable interface (e.g., Mobile High-Definition Link (MHL) cable interface), and/or other interface. Streaming device 124 may be communicatively coupled to gateway 122. In some implementations, media content display device 124 may be configured to be housed outside of gateway 122.

In some embodiments, streamed media content may include media content contained on authenticated client computing platform 104, a media content provider available over the Internet, and/or other media content. Streamed media content may be accessed with authenticated client computing platforms 104. In some implementations, streamed media content may be accessed with a streaming application installed on client computing devices 104.

In some embodiments, one or more streaming device 124 may be configured to be controlled by a network administrator via network 103. The administrative control upon streaming device 124 may be effectuated via a wireless network connection, a wired Ethernet connection, and/or by other connection.

Media content display device 128 may be configured to display audio and visual media content transmitted by streaming device 124 and/or other devices. Media content display device 128 may commonly be referred to as an audio/visual device (e.g., a television). One or more media content display device 128 may be configured to include at least one of an HDMI connector, a USB connector, a tuner, auxiliary interface, a processor that controls audio and visual signal, and/or other components.

Media content display device 128 may be configured to receive media content from client computing platforms 104 via streaming device 124 connected to media content display device 128 via a High Definition Multimedia Interface (HDMI), a Universal Serial Bus (USB) and/or other connections.

As alluded to above, client computing platform 104 example environment 100 may be configured to control the media content displayed on media content display device 128. For example, as illustrated in FIG. 4 media control server(s) 102 may include one or more physical processors 124, and/or other components. The one or more physical processors 124 may be configured by machine-readable instructions 105 comprising one or more computer program components. In some embodiments, the computer program components may include one or more of an access component 106, a streaming component 108, a control component 110, a maintenance component 112, and/or other components.

In some embodiments, media control server 102 may include a plurality of hardware, software, and/or firmware components operating together to provide the functionality attributed herein to server(s) 102. For example, media control server 102 may be implemented by a cloud of computing devices operating together as server 102.

In some embodiments, access component 106 may be configured to control user access to network 103 and/or other communication networks. Network 103 may be used to access the Internet and/or other components. Access component 106 may be configured to control user requests to access network 103. Requests to access network 103 may be made by users via client computing platforms 104 associated with the users, and/or other devices. Access component 106 may be configured to connect client computing devices 104 to the Internet through a wireless, wired and/or other connection to network 103.

In some embodiments, access component 106 may be configured to receive authenticating information from users associated with client computing platforms 104. Access component 106 may be configured to authenticate users attempting to access network 103 by comparing authenticating information and/or other parameters received by users with information stored within system 100. Access component 106 may be configured to allow access to the Internet to users that have been successfully authenticated.

In some embodiments, access component 106 may be configured to control user 150 access to gateway 122, streaming device 124, and/or other devise operating on network 103. For example, access component 106 may be configured to control access to gateway 122, streaming device 124 by authenticating users associated with client communication platforms 104 that have been authenticated to network 103 and/or other communication networks. In some embodiments, access component 106 may be configured to receive authenticating information from users associated with client computing platforms 104. Access component 106 may be configured to authenticate users attempting to access gateway 122, streaming device 124, and/or other devices by comparing authenticating information and/or other parameters received by users with information stored within media control server 102. In some embodiments, access component 106 may be configured to allow access to gateway 122, including its components (e.g., Wifi router module), streaming device 124, and/or other devices to users that have been successfully authenticated.

In some embodiments, access component 106 may be configured to require individual users to provide authentication information and/or other parameters upon attempting to establish a wireless connection with gateway 122 via respective client computing platforms 104. For example, users may enter authentication information and/or other parameters via an application or a web browser running on client computing platform 104. Authentication information may include password, user name, and/or other authenticating information. Other parameters may include user name, user location, payment information, and/or other information. Upon verifying that correct authentication information was provided, access component 106 may be configured to provide users access to network 103, including other devices operating in that network.

In some embodiments, access component 106 may be configured to associate a particular user with a particular gateway 122 based on their authentication parameters. For example, a user in a multi-room environment, such as hotel, may be provided with authentication information that corresponds to the media content streaming gateway located in that users room. In some embodiments, gateway 122 may act as an access point configured to provide network access to users 150. For example, a guest may be provided with a user name, a password, and/or other authenticating information during a hotel check-in. By entering the authentication information, guests may be able to access hotel's network via gateway 122 acting as an access point. For example, the WiFi router module of the gateway 122 may be configured to connect the guest to the hotel's network.

In some embodiments, access component 106 may be configured to maintain associations between individual media content streaming gateways in a multi-room environment and individual users. For example, one or more media content streaming gateway may be associated with one or more user. A In some embodiments, associations between media content streaming gateway and users may be one or more of one-to-one, many-to-one, one-to-many, many-to-many, and/or other associations.

In some embodiments, access component 106 may be configured to control access of authenticated users to their designated media content streaming gateways 122. For example, a guest in a hotel may be provided with authentication information upon check-in, as alluded to above. Upon entering the designated room, the guest may access hotel's network by providing authentication information. Additionally, the guest may also access gateway 122 associated with that particular hotel room. By authenticating onto hotel's network, the guest may be able to stream media content via streaming device 124 coupled to a gateway 122 associated with guest's room.

In some embodiments, streaming component 108 may be configured to effectuate transmission of media content received from client computing device 104 for display on a media content display device 128.

In some embodiments, media content transmitted by client computing device 104 may be received by gateway 122, as described herein. For example, the media content may be received wirelessly. In some embodiments, streaming component 108 may be configured to obtain the media content wirelessly received by gateway 122 and transmit it to the streaming device 124 communicatively coupled to the gateway device 122. The streaming device 124 would then transmit the audio and visual signals (media content) as corresponding HDMI signals for transmission and display over media content display device 128.

In some embodiments, streaming component 108 may be configured to establish a connection with a media server from where the media content is transmitted via client computing device 104. For example, streaming component 108 may use application programming interface (API) connection with the media server. Upon establishing the connection with the media server allows streaming component 108 to transmit the media content from the gateway 122 to the streaming device 124 even when client computing device 104 is no longer in use.

In some embodiments, control component 110 may be configured to permit users to effectuate control over the streamed media content (i.e., content displayed on media content display device 128). For example, control component 110 may be configured to allow users associated with authenticated client computing platforms 104 to interact with the streamed content using client computing device 104.

In some embodiments, control component 110 may be configured to receive user input intended to control streamed media content. For example, user input may include selection of particular media content (e.g., a movie, a video, a photo album), interaction with particular media content (e.g., flipping through pictures of the photo album), and/or other controls.

In some embodiments, maintenance component 112 may be configured to maintain authentication information used to authenticate users associated with client computing platforms 104 to connect network 103.

In some embodiments, maintenance component 112 may be configured to manage associations between authenticated users within network 103 and media content streaming devices 124. In some embodiments, maintenance component 112 may be configured to automatically update and/or reset authentication information associated with a particular gateway 122 based on occurrence of certain events and/or other triggers.

For example, a guest in a hotel may be issued a user name and password for accessing hotel's wireless network. This user name and password issued by the hotel at check-in may also be configured by maintenance component 112 as the same authenticating parameters for accessing gateway 122 associated with the guest's room. Once the user checks-out of the hotel, maintenance component 112 may be configured to remove the authentication parameters associated with that user from accessing gateway 122.

In some embodiments, maintenance component 112 may be configured to monitor power usage and/or other information associated with gateway 122, streaming device 124, and/or other devices.

In some embodiments, maintenance component 112 may be configured to obtain input from a power regulator within gateway 122 and/or other component and evaluate streaming device 124 power usage. The power usage evaluation may include a determination whether a power disruption exists within gateway 122, media content streaming device 122, and/or other devices. In some embodiments, maintenance component 112 may be configured to communicate power status and/or other information associated with gateway 122, streaming device 124, and/or other devices. In some embodiments, maintenance component 112 may be configured to transmit and display a status notification. The power status notification may be displayed on an administrative user interface associated with client computing platform 104 and/or other devise.

In some embodiments, maintenance component 112 may be configured to monitor wireless communications and data transmissions between client computing device 104 and gateway 122 over network 103. Similarly, maintenance component 112 may be configured to monitor wired communications data transmissions between gateway 122 and streaming device 124. For example, maintenance component 112 may be configured to detect and identify network and/or communication disruptions. In some embodiments, maintenance component 112 may be configured to transmit network status and/or other information to a user or another system (e.g., administrator).

In some embodiments, maintenance component 112 may be configured to monitor power consumptions associated with gateway 122 and streaming device 124. For example, maintenance component 112 may detect power consumption fluctuations transmit associated status of power consumption and/or other information to a user or another system (e.g., administrator).

In some embodiments, maintenance component 112 may be configured to detect the state of the media content display device 128 (e.g., on or off) via input received from the third interface, which is configured to couple display device 128 (e.g., mini-USB interface 353 illustrated in FIG. 3). In some embodiments, maintenance component 112 may be configured to detect the operational mode selected via user interface (e.g., user interface 351 illustrated in FIG. 3). By detecting the state of the display device 128, maintenance component 112 may be configured to power on or off gateway 122. For example, upon detecting that display device 128 is turned on and the operational mode is selected as non-continuous (gateway 122 is only on when media display device 128 is also on), maintenance component 112 may be configured to power on gateway 122, if it is currently powered off. Similarly, upon detecting that display device 128 is turned off and the operational mode is selected as non-continuous, maintenance component 112 may be configured to power off gateway 122, if it is currently powered on. In some embodiments, maintenance component 112 may be configured to power on gateway 122 based on the state of the display device 128 by transmitting the appropriate command to a transistor (e.g., MOSFET 348 illustrated in FIG. 3.

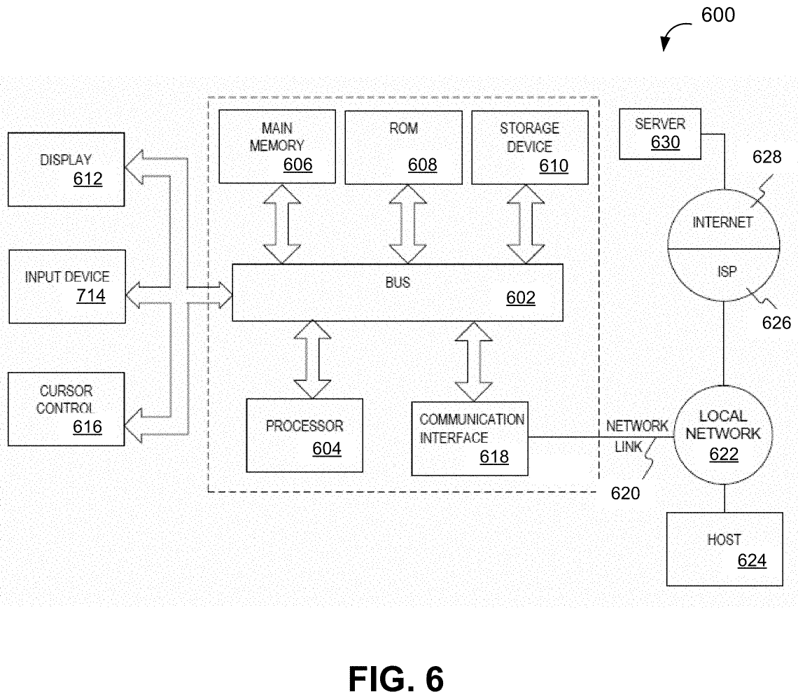

FIG. 5 illustrates a method 500 for controlling media content with a wireless device in a wireless communication network via a media content streaming device communicatively coupled to a media content streaming gateway, in accordance with one or more implementations. The operations of method 500 presented below are intended to be illustrative. In some implementations, method 500 may be accomplished with one or more additional operations not described, and/or without one or more of the operations discussed. Additionally, the order in which the operations of method 500 are illustrated in FIG. 6 and described below is not intended to be limiting.

In some embodiments, method 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 500 in response to instructions stored electronically on an electronic storage medium. The one or more processing devices may include one or more devices configured through hardware, firmware, and/or software to be specifically designed for execution of one or more of the operations of method 500.

At an operation 502, a client computing device associated user may be authenticated onto a wireless network. The authentication information and/or authentication parameters may include a user name, a user location and/or other information. At an operation 504, the client computing platform connected to the wireless network may be connected to a media content streaming gateway. In some implementations, operation 502 and operation 504 may be performed by one or more physical processors executing an access component the same or similar to access component 106.

At an operation 506, the media content received by the media content streaming gateway from the authenticated client computing device may be transmitted to a media content streaming device coupled to a media content gateway. In some implementations, operation 506 may be performed by one or more physical processors executing a streaming component the same or similar to streaming component 108.

At an operation 508, media content transmitted by media content streaming device and displayed on a media content display device may be controlled by the user via their client computing platform. In some implementations, operation 408 may be performed by one or more physical processors executing an orientation component the same or similar to control component 110.

At an operation 510, associations between multiple media content streaming gateways and users in a multi-room environment may be maintained. In some implementations, operation 510 may be performed by one or more physical processors executing a maintenance component the same or similar to maintenance component 112.

Where circuits are implemented in whole or in part using software, in one embodiment, these software elements can be implemented to operate with a computing or processing system capable of carrying out the functionality described with respect thereto. One such example computing system is shown in FIG. 6. Various embodiments are described in terms of this example-computing system 600. After reading this description, it will become apparent to a person skilled in the relevant art how to implement the technology using other computing systems or architectures.

FIG. 6 depicts a block diagram of an example computer system 600 in which various of the embodiments described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may be coupled via bus 602 to a display 612, for displaying information to a computer user. An input device 614, including a microphone, is coupled to bus 602 for communicating information and command selections to processor 604. An output device 616, including a speaker, is coupled to bus 602 for communicating instructions and messages to processor 604.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “system,” “database,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 605. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 605. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A media content transmission system, the system comprising:
a streaming device configured to communicatively couple a display device;
a gateway device comprising:
a WiFi module;
a first interface configured to communicatively couple the streaming device,
a second interface configured to communicatively couple a power source, and
a third interface configured to communicatively couple the display device,
a plurality of mobile devices operated by a plurality of users, each mobile device configured to transmit media content from the mobile device onto the display device via the streaming device during a wireless data communication session;
wherein the wireless communication session between an individual mobile device and the WiFi module of the gateway device is established by authenticating a user associated with the individual mobile device during an authentication process by assigning the individual mobile device to the WiFi module; and
wherein the assigned individual mobile device transmits media content onto the display device via the streaming device communicatively coupled to the gateway device.

2. The system of claim 1, wherein the streaming device is configured to be communicatively coupled to the display device via a high definition multimedia interface (HDMI).

3. The system of claim 1, wherein the assigned WiFi module of the gateway device is communicatively coupled to a network.

4. The system of claim 3, wherein the individual mobile device is configured to access a global internet using the assigned WiFi module of the gateway device.

5. The system of claim 4, wherein the individual mobile device is configured to transmit media content to the gateway device over one or more communication protocols comprising at least one of Bluetooth, Wi-Fi, near field communication, and RFID communication protocols; wherein the media content is received from the global internet.

6. The system of claim 5, wherein the media content transmitted by the individual mobile device is received by the gateway device and transmitted to the streaming device via the first interface for display onto the display device.

7. The system of claim 6, wherein the first interface of the gateway device comprises a micro-USB port configured to interface with a micro-USB receptacle onboard the streaming device.

8. The system of claim 7; wherein the first interface is configured to deliver an electrical power flow for powering the streaming device; and wherein the electrical power flow is directed from the power source communicatively coupled to the second interface.

9. The system of claim 8, wherein the gateway device further comprises a power regulator configured to regulate the electrical power flow to the streaming device.

10. The system of claim 1, wherein the gateway device further comprises a user interface configured to receive input for specifying a mode of operation of the streaming device, wherein the mode of operation comprises a first mode and a second mode.

11. The system of claim 10, wherein the first mode of operation allows the streaming device to be powered continuously, and the second mode of operation allows the streaming device to be powered non-continuously.

12. The system of claim 11, wherein the gateway device further comprises a power MOSFET configured to:
transmit a signal to power on the streaming device upon receiving a first input from the display device; and
transmit a signal to power off the streaming device upon receiving a second input from the display device;
wherein the first input from the media display device indicates that the display device is powered on, and the second input from the media display device indicates that the display device is powered off.

13. The system of claim 12, wherein the first input and the second input from the display device is delivered to MOSFET via the third interface of the gateway device; and wherein the third interface comprises mini-USB receptacle configured to configured to interface with a min-USB port onboard the display device.

14. A method for transmitting media content in a multi-user environment, the method comprising:
establishing a wireless communication session between an individual mobile device of a plurality of mobile devices operated by a plurality of users and a gateway device by authenticating the individual mobile device during an authentication process; and
transmitting media content received by the gateway device from the authenticated mobile device to a display device via a streaming device during the wireless data communication session, wherein the streaming device is configured to communicatively couple the display device;
wherein the gateway device is configured to communicatively couple the streaming device.

15. The method of claim 14, wherein the communicative coupling of the gateway device of the streaming device comprises communicatively coupling a first interface of the gateway device to the streaming device;
wherein the first interface of the gateway device comprises a micro-USB port configured to interface with a micro-USB receptacle onboard the streaming device.

16. The method of claim 15, wherein transmitting the media content received by the gateway device for display onto the display device comprises transmitting the media content to the streaming device via the first interface.

17. The method of claim 16, wherein transmitting media content received by the gateway device for display onto the display device comprises communicatively coupling the streaming device to the display device via a high definition multimedia interface (HDMI).

18. The method of claim 14, establishing the wireless communication session between the individual mobile device and the gateway device comprises assigning the individual mobile device to a WiFi module of the gateway device; wherein the WiFi module of the gateway device is communicatively coupled to a network.

19. The method of claim 18, wherein transmitting the media content to the gateway device by the individual mobile device comprises accessing, by the individual mobile device, a global internet using the assigned WiFi module of the gateway device.

20. The method of claim 19, wherein transmitting the media content to the gateway device by the individual mobile device comprises transmitting the media content over one or more communication protocols comprising at least one of Bluetooth, Wi-Fi, near field communication, and RFID communication protocols; wherein the media content is received from the global internet.

21. A gateway device for transmitting media content over a network, the gateway device comprising:
a WiFi module communicatively coupled to a network;
a first interface configured to communicatively couple a streaming device, the streaming device communicatively coupled to a display device; and
a second interface configured to communicatively a power source and configured to power the streaming device through the first interface; and
wherein the gateway device is configured to transmit media content received from a mobile device of a plurality of mobile devices operated by a plurality of users during an authenticated wireless data communication session between the mobile device and the gateway device for display onto a the display device by transmitting the media content to the streaming device via the first interface;
wherein the authenticated wireless communication session is established by associating the mobile device with the gateway device by assigning the mobile device to the WiFi module, wherein the assigned WiFi module is communicatively coupled to a network.
